(19) United States
(12) Patent Application Publication
(10) Pub. No.: US 2003/0024947 A1
(43) Pub. Date: Feb. 6, 2003

(54) Flip top piercing tip cap

(76) Inventors: Abhay Joshi, Irvine, CA (US); Awni I. Jadallah, Irvine, CA (US)

Correspondence Address: Walter A. Hackler, Ph.D., Suite B, 2372 S.E. Bristol, Newport Beach, CA, 92660-0755, US

(21) Appl. No.: 09/918,847

(22) Filed: Jul. 31, 2001

(51) Int. Cl. B67D 5/00

(52) U.S. Cl. 222/83

(57) ABSTRACT

A medicament disposing container includes a bottle having a large diameter for storage of a medicament and an initially sealed narrow nozzle. A cap is threadably engaged on the nozzle and includes a piercer for penetrating a nozzle upon rotation of a cap on the nozzle. The piercer as a tapered end and a lumen therethrough including communication with a port in a piercer circumference. Upon penetration of the nozzle, the port is disposed proximate an internal surface of the nozzle in order to provide a restricted passage for throttling medicament therepast in order to enable dropwise dispensing of the medicament through the piercer lumen.

The present invention generally relates to dispensing containers and is more particularly related to plastic bottles blow molded having a dispensing cap which includes a piercer for opening the sealed bottle. Plastic bottles are of common usage and are often filled with a medicament and include a neck with an outer thread onto which a threaded cap is provided for sealing the container after piercing a top thereof.

In some instances, the cap includes a piercer for penetrating a top of a container and thereafter is used as the sealing cap. In other instances, the cap includes a piercer having a lumen therethrough for the dispensing of medicament therethrough and a separate stopper, or secondary cap, is utilized to seal the cap lumen.

Many attempts have been made to provide a piercing cap and bottle combination in which consistent dropwise dispensing of medicament can be achieved. This is particularly important in the case of ocular medication, such as eye drops. These problems are recognized in U.S. Pat. No. 5,427,275 which includes a cap designed as a dispenser in the form of a dropper. Such caps include long channels which are tapered for controlling dispensing of a medicament, however, are difficult and expensive to manufacture.

Other patents such as U.S. Pat. Nos. 5,711,453 and 6,076,704 include a cap with a dispensing nozzle and a separate spike within the cap for piercing a membrane of the bottle when the cap is threaded onto the neck portion of the bottle to provide access to the medicament contained therein. The spike includes a passageway includes in fluid communication with the dispensing nozzle on the cap for enabling dispensing of the medicament.

The spike may be separate or unitarily molded within the cap. In either case, considerable molding expense is required which results in an expensive container. In addition, poor fluid dispensing control, especially for dropwise dispensing of a medicament, is provided since there is no internal control of fluid flow to and through the spike.

Other patents such as U.S. Pat. No. 5,228,592 provide for a spout and sealing cap which includes a hollow piercing and dispensing element with sharp edges designed to pierce the lid. Such arrangements however, do not lend themselves to use for the accurate, metering, or throttling of a medicament from a bottle in dropwise manner as is necessary for medicaments.

### SUMMARY OF THE INVENTION

A medicament dispensing container in accordance with the present invention generally includes a bottle having a large diameter for storage of a medicament and an initially sealed narrow nozzle. A cap threadably engages the nozzle and includes a piercer for penetrating the nozzle upon closing rotation of the cap on the nozzle. The piercer has a tapered end and a lumen therethrough in fluid communication with a port in a piercer circumference. This offset port prevents the lumen from being clogged with material from the bottle wall during penetration thereof.

Upon penetration of the nozzle, the port is disposed proximate an internal surface of the nozzle in order to provide a restricted passage for throttling medicament therepast, thus enabling dropwise dispensing of the medicament through the piercer lumen. The cap remains on the bottle nozzle and a sealing stopper is provided for sealing the piercer lumen.

More particularly, the nozzle includes a flat piercable end having a small diameter compared to a diameter of the external threads disposed on the nozzle. This structural arrangement provides mechanical advantage upon closing rotation of the cap for applying sealing pressure between the nozzle and a surface surrounding the piercer.

Accordingly, the small diameter of the nozzle end enhances a sealing arrangement between the nozzle and the cap, and further provides a narrow passageway for enabling the throttling of fluid for enhanced dropwise dispensing of medicament from the bottle.

The cap preferably includes a flat top having a thickness comparable to a wall thickness of a cap and the piercer protrudes from the flat top less than the flat top thickness in order to enhance droplet formation and prevent contamination of the flat top with medicament during dispensing thereof. In addition, this structure facilitates easy mold manufacture and an inexpensive unit.

Preferably, the container further includes a temporary stop to prevent inadvertent rotation of the cap and penetration of the piercer into the nozzle. This features is important in retail situations where the bottles may be stored on shelves and need to remain sealed until initial use by a consumer.

In that regard, the temporary stop may include a tear away strip or a crushable ring in order to provide tamper proof evidence of bottle and cap integrity. To provide a unitary container, the stop may include a flip top attached to the cap.

In order to control a droplet size, the piercer may be provided with a plurality of ports in the piercer circumference each of which are disposed approximate the internal surface of the nozzle in order to provide a restricted passage for throttling a medicament to their past.

### BRIEF DESCRIPTION OF THE DRAWINGS

The present invention will be better understood when taken in conjunction with the following drawings in which:

FIG. 1 is an exploded perspective view of a medicament dispensing container in accordance with the present invention generally showing a bottle, a cap, for threadably engaging a nozzle on the bottle and a flip top sealing stopper for sealing a piercing lumen protruding from a cap.

FIG. 2 is a cross-section of the nozzle portion of the bottle shown in FIG. 1 and cap showing a piercer in position for penetrating the nozzle upon closing rotation of the cap on nozzle threads; and

FIG. 3 is a cross-sectional view similar to FIG. 2 showing the piercer penetrating a nozzle cap and establishing a restricted passage between a piercer port and an inside diameter of the nozzle for throttling medicament therepast in order to enable dropwise dispensing of the medicament through the piercer lumen.

### DETAILED DESCRIPTION

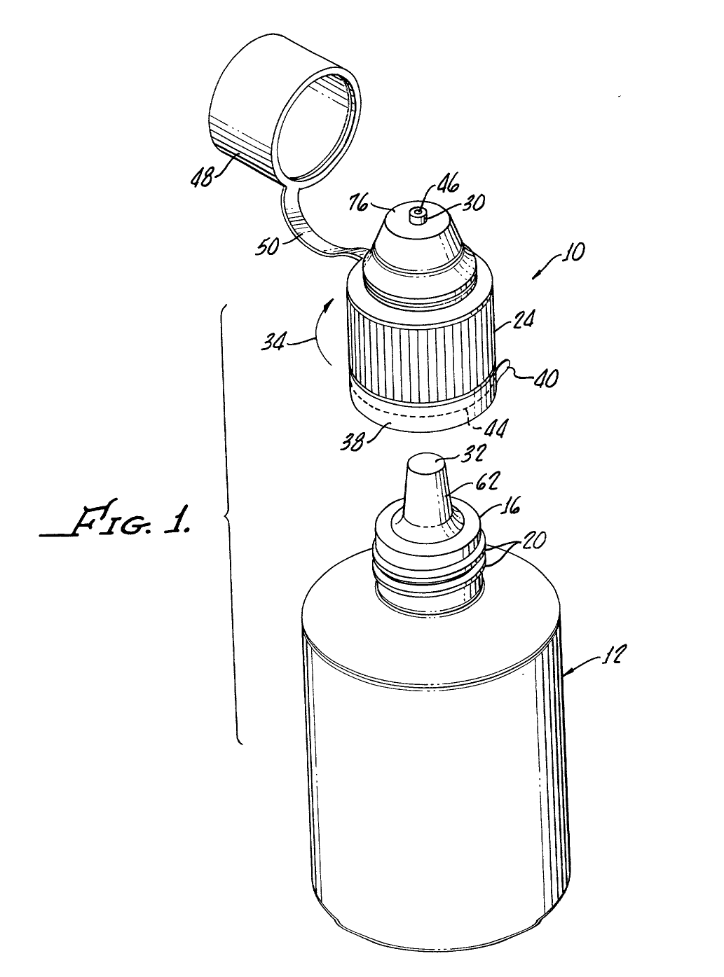

With reference to FIG. 1, there is shown a medicament dispensing container 10 generally including a bottle 12 having a lower portion 14 with a relatively large diameter for storage of a medicament and an initially sealed narrow nozzle 16. The bottle 10 may be blow molded from any suitable material for containing a particular medicament.

Threads 20 on the nozzle 16 enable a cap 24 to threadably engage the nozzle 16 has will be hereinafter described in greater detail. A piercer 30 penetrates a flat piercable end 32 in the nozzle 16 upon closing rotation of the cap 24 as indicated by the arrow 34. The cap and nozzle are molded unitarily from any suitable material in order to provide a piercer 30 with sufficient strength to penetrate the end 32. Suitable materials are high impact polystyrene, ABS, hard propylene and high density polypropylene as examples.

To prevent inadvertent rotation of the cap 24 and premature penetration of the nozzle end 32, a temporary stop 38 may be provided which also serves as a tamper proof evidence that the non-experience tampering before use by the consumer. The temporary stop may include a tab 40 for enabling the temporary stop 38 to be removed by the consumer or perforations 44 may be provided in the temporary stop for enabling it to act as a crushable ring.

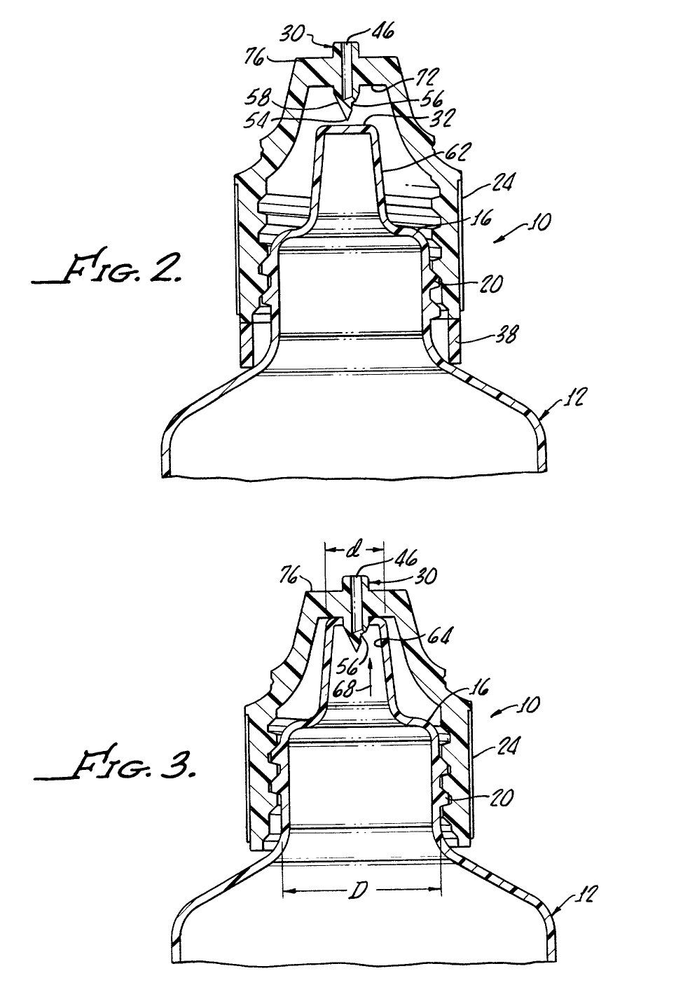

After rotation of the cap and penetration of the nozzle end 32 by the piercer 30, a piercer lumen 46 may be sealed by a flip top cap 48 tethered to the cap 24 by a bendable strip 50. With reference to FIGS. 2 and 3, the piercer 30 includes a tapered end 54 for penetrating the nozzle end 32 and a port 56 in a piercer circumference 58 is in fluid communication with the lumen 46.

The offset relationship of the port 56 with the tapered end of 54 inhibits the entrance of material from the nozzle end 32 from entering lumen 46 upon penetration as shown in FIG. 3.

The cross-section shown in FIGS. 2 and 3 illustrates one port 56, however, other ports (not shown) which may be utilized, are not visible in the cross-sections shown.

A nozzle tip 62 subtending the end 32 has a narrowing diameter and upon penetration of the piercer 30 through the end 32, the port 56 is disposed proximate an internal surface 64 which provides for a restricted passage, as indicated by the arrow 68 for throttling medicament therepast in order to enable dropwise distending of the medicament through the piercer lumen 46.

The narrowing nozzle tip 62, and importantly, flat small nozzle end 32 in combination with the large diameter, D, of the threads 20 provide a mechanical advantage to the end 32, having a small diameter, d, so that increased pressure for sealing is provided between the nozzle end 32 and an area 72 surrounding the piercer 30. This insures a fluid tight seal which is not obtainable in prior art devices having a large membrane for piercing.

The cap may be molded economically utilizing relatively uniform wall thickness with a flat top having a thickness comparable to the wall thickness of the cap 24. As shown in FIGS. 2 and 3 the piercer 32 protrude from the flat top 76 less than a flat top thickness in order to enhance droplet formation and prevent contamination of the flat top 76 with medicament during dispensing thereof.

Although there has been hereinabove described a medicament dispensing container in accordance with the present invention for the purpose of illustrating the manner in which the invention may be used to advantage it will be appreciated that the invention is not limited thereto. Accordingly, any and all modifications, variations, or equivalent arrangements which may occur to those skilled in the art, should be considered to be within the scope of the invention as defined in the appended claims.

What is claimed is:

1. A medicament dispensing container comprising:
a bottle having a large diameter for storage of a medicament and an initially sealed narrow nozzle;
a cap threadably engaging the nozzle and including a piercer for penetrating the nozzle upon closing rotation of said cap on the nozzle, said piercer having a tapered end and a lumen therethrough in fluid communication with a port in a piercer circumference, upon penetration of the nozzle said port being disposed proximate an internal surface of the nozzle in order to provide a restricted passage for throttling medicament therepast in order to enable dropwise dispensing of said medicament through the piercer lumen; and
a sealing stopper for sealing the piercer lumen.

2. The container according to claim 1 wherein the nozzle includes a flat pierceable end having a small diameter compared to a diameter of external threads disposed on the nozzle, for reviewing said cap, in order to provide mechanical advantage upon closing rotation of the cap for applying sealing pressure between the nozzle end and a surface surrounding said piercer.

3. The container according to claim 2 wherein said cap includes a flat cop having a thickness comparable to a wall thickness of said cap and said piercer protruding from said flat top lens than the flat top thickness in order to enhance droplet formation and present contamination of said flat top with medicament during dispensing thereof.

4. The container according to claim 3 wherein said cap further comprises a temporary stop to prevent inadvertent rotation of said cap and penetration of said piercer into the nozzle.

5. The container according to claim 4 wherein said temporary stop comprises a tear away strip.

6. The container according to claim 4 wherein said temporary stop comprises a crushable ring.

7. The container according to claim 4 wherein the stopper comprises a flip top attached to said cap.

8. A medicament dispensing container comprising:
a bottle having a large diameter for storage of a medicament and an initially sealed narrow nozzle;
a cap threadably engaging the nozzle and indicating a piercer for penetrating the nozzle upon closing rotation of said cap on the nozzle, said piercer having a tapered end and a lumen therethrough in fluid communication with a plurality of ports in a piercer circumference, upon penetration of the nozzle the ports being disposed proximate an internal surface of the nozzle in order to provide a restricted passage for throttling medicament therepast in order to enable dropwise dispensing of said medicament through the piercer lumen; and
a sealing stopper of sealing the piercer lumen.

9. The container according to claim 8 wherein the nozzle includes a flat pierceable end having a small diameter compared to a diameter of external threads disposed on the nozzle, for receiving said cap, in order to provide mechanical advantage upon closing rotation of the cap for applying sealing pressure between the nozzle end and a surface surrounding said piercer.

10. The container according to claim 9 wherein said cap includes a flat tip having a thickness comparable to wall thickness of said cap and said piercer protrudes from said flat top lens than the flat top thickness in order to enhance droplet formation and present contamination of said flat tip with medicament during dispensing thereof.

11. The container according to claim 10 wherein said cap further comprises a temporary stop to prevent inadvertent rotation of said cap and penetration of said piercer into the nozzle.

12. The container according to claim 11 wherein said temporary stop comprises a tear away strip.

13. The container according to claim 11 wherein said temporary stop comprise a crushable ring.

14. The container according to claim 11 wherein the stopper comprises a flip tip attached to said cap.
